(19) United States
(12) Patent Application Publication
(10) Pub. No.: US 2004/0059740 A1
(43) Pub. Date: Mar. 25, 2004

(54) Document management method

(76) Inventors: Noriko Hanakawa, Ikoma (JP); Takashi Saito, Kobe (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/641,055

(22) Filed: Aug. 15, 2003

(30) Foreign Application Priority Data
Sep. 19, 2002 (JP) 2002-272426

(51) Int. Cl. G06F 7/00

(52) U.S. Cl. 707/100

(57) ABSTRACT

In a conventional document classification method, because a document is classified by only adaptability of an occurrence word of a document with a conditional expression of each folder, abstract levels of a classified folder and description contents of the document do not match or it is difficult to discriminate a field and a theme. The present invention obtains a candidate rate of a folder by classification adaptability into the folder and abstract adaptability among folders on one layer. The folder into which the document ought to be classified in accordance with a value of the candidate rate is decided, and then a folder layered structure to which the document ought to be assigned is decided using folder candidate distribution.

### BACKGROUND OF THE INVENTION

1. Field of the Invention

The present invention relates to an art for automatically classifying an unclassified document into a folder having a layered structure in accordance with the contents. Further, the present invention relates to an art for automatically discriminating a field, a theme, a purpose of creation, and a viewpoint to be dealt with in a document.

2. Description of the Related Art

As an example of a prior art of a document classification method, a conditional expression for which a document and a folder are fit is set for each folder and the adaptability of the document and each folder is calculated respectively. As a result, a folder of high adaptability is specified as an assigned folder of the document. Further, if the adaptability of multiple folders is high, the lowest level folder specified as the assigned folder of the document is disclosed in Japan Unexamined Patent Application Publication No. Hei 7-49875.

As an example of a document discrimination method, a method for classifying a document for every field based on frequency in the occurrence of a keyword in the document is disclosed in Japan Unexamined Patent Application Publication No. Hei 6-282587.

### SUMMARY OF THE INVENTION

In Japan Unexamined Patent Application Publication No. Hei 7-49875, although a folder has a layered structure, that is, an abstract concept structure, the folder was merely determined by only adaptability of the folder with a conditional expression. Further, in the aforementioned prior art, even when multiple high adaptability folders are provided, the document is assigned to the lowest level folder.

The present invention provides a classification method that can determine by abstract adaptability calculation which layer level a folder ought to be assigned to, and that, even when multiple high adaptability folders are provided, can classify the document into a folder that is a upper abstract concept instead of being classified into the lowest level folder.

According to Japan Unexamined Patent Application Publication No. Hei 7-9875, even when Document A and B belong to a totally different field, both the documents are assumed to belong to the same field if they are determined only by their similarities when the same word occurs frequently. Therefore, it is difficult for a method for classifying a document from frequency in the occurrence of a word of the document to accurately discriminate a field and a theme the document deals with.

The present invention provides a document classification method that can respond to the case in which the abstraction of the contents a document deals with and the abstract adaptability in a folder layered structure of an assigned folder of an automatic classification result do not match when the document is classified into the folder.

Further, the present invention provides a document classification method in consideration of a field and a theme of a document when the field of the document whose contents are unknown is requested based on a similarity with a document whose field is already known.

Further, the present invention provides a program for displaying index data plainly when a user classifies a document.

The document management method of the present invention using a computer accepts input of a file name from a user, reads information about a folder stored previously, calculates classification adaptability based on the information about the accepted file name and the read folder, and displays a calculated result on a screen.

### BRIEF DESCRIPTION OF THE DRAWINGS

Preferred embodiments of the present invention will be described in detail based on the followings, wherein:

FIG. 1 is an example of the entire configuration of a document management system that is an embodiment in the present invention;

FIG. 2 is an example of a folder layered structure registration screen which a document management client program displays;

FIG. 3 is an example of a document classification screen the document management client program displays;

FIG. 4 is an example of a document classification discrimination screen which the document management client program displays;

FIG. 5 is an example of a flowchart showing a flow of processing of a document management server program;

FIG. 6 is an example of a registered folder layered structure;

FIG. 7 is an example in which classification adaptability of a folder having a folder layered structure is calculated;

FIG. 8 is an example in which abstract adaptability of a sibling folder having the folder layered structure is calculated and an example in which a candidate rate of each folder is calculated;

FIG. 9 is an example of an attribute added to the folder layered structure;

FIG. 10 is an example in which distance from a folder is calculated for the purpose of candidate distribution calculation; and

FIG. 11 is an example in which an average of a candidate rate of the folder equal to the distance was rearranged in descending order for the purpose of the candidate distribution calculation.

### DESCRIPTION OF THE PREFERRED EMBODIMENTS

Preferred embodiments of the present invention are described with reference to the drawings.

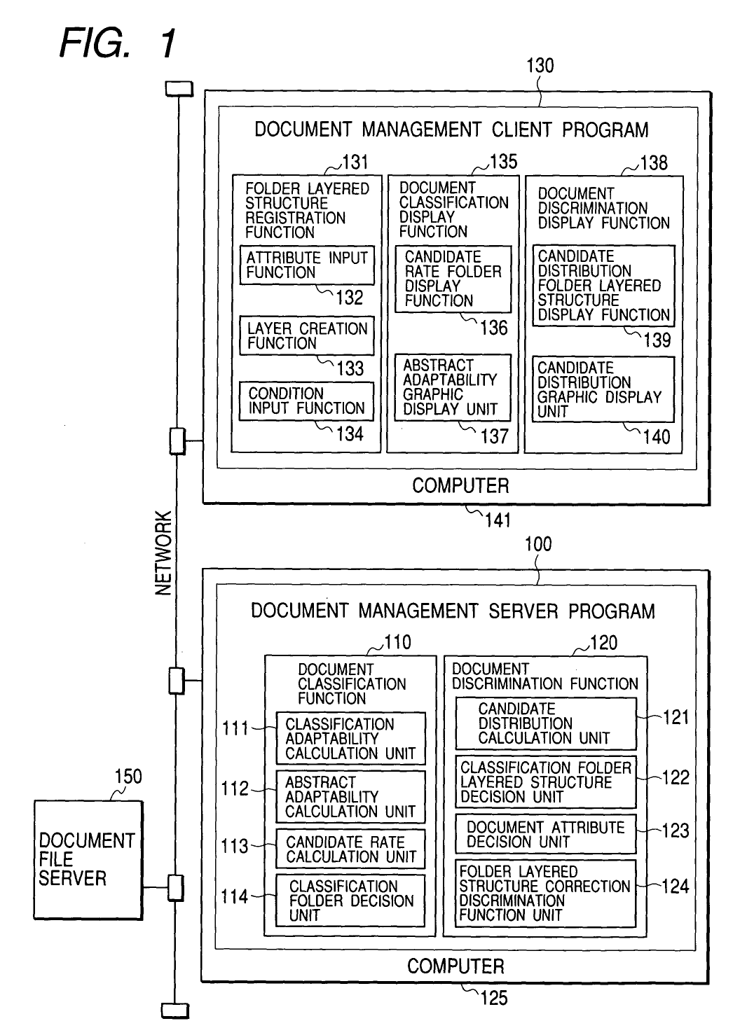

FIG. 1 is an example of the system configuration of the present invention. A computer 125 is operated by a document management server program 100. A computer 141 is operated by a document management client program 130. A document file server 150 manages a storage device that stores a document. Moreover, the storage device that stores the document is not shown, but it may also be included in the document file server 150. If a document file server can be managed, the storage device may be even a storage medium that can be accessed via a network or another device.

The document management client program 130 includes a folder layered structure registration function 131, a document classification display function 135, and a document discrimination display function 138. The folder layered structure registration function 131 includes an attribute input function 132, a layer creation function 133, and a condition input function 134. The document classification display function 135 includes a candidate rate folder display function 136 and an abstract adaptability graphic display unit 137. The document discrimination display function 138 includes a candidate distribution folder layered structure display function 139 and a candidate distribution graphic display unit 140. Moreover, illustration is omitted, but there are multiple computers on which the document management client program 130 is executed. Each of the computers may also gain access to a document management client program as the need arises.

The document management server program 100 includes a document classification function 110 and a document discrimination function 120.

The document classification function 110 includes a classification adaptability calculation unit 111, an abstract adaptability calculation unit 112, a candidate rate calculation unit 113, and a classification folder decision unit 114. The document classification function 110 calculates a candidate rate by the candidate rate calculation unit 113 based on the classification adaptability of a folder and a document calculated by the classification adaptability calculation unit 111 and the abstract adaptability between each layer level of a folder layered structure and the document calculated by the abstract adaptability calculation unit 112, and decides the folder to which the document ought to be assigned by the classification folder decision unit 114.

The result of the document classification function 110 is displayed by the document classification display function 135 of the document management client program 130. Further, the document classification display function 135 includes the candidate rate folder display function 136 that graphically displays the result of the candidate rate calculation unit 113 of the document classification function 110 and the abstract adaptability graphic display unit 137 that graphically displays the result of the abstract adaptability calculation unit 112.

The classification adaptability calculation unit 111 calculates classification adaptability of a folder and a document. The calculation of this classification adaptability may use a method for associating a conformable conditional expression for the document with the folder and calculating the adaptability of a word that occurs in the conditional expression and the document in the same manner as Japan Unexamined Patent Application Publication No. Hei 7-49875 or other methods.

The document discrimination function 120 includes a candidate distribution calculation unit 121 that calculates candidate distribution of a document and a folder layered structure, a classification folder layered structure decision unit 122 that decides the folder layered structure to which the document ought to be assigned, a document attribute decision unit 123 that sets a field, a theme, a purpose of creation, and a viewpoint set in the folder layered structure as attributes for each attribute value, and a folder layered structure correction discrimination function unit 124 that discriminates correction of the folder layered structure by comparing the candidate distribution of the folder layered structure and a threshold.

The processing result of the document discrimination function 138 is displayed by the document discrimination display function 120 of the document management client program 130. Further, the document discrimination display function 138 includes the candidate distribution folder layered structure display function 139 and the candidate distribution graphic display unit 140 that graphically display the result of the candidate distribution calculation 121 of the document discrimination function 120.

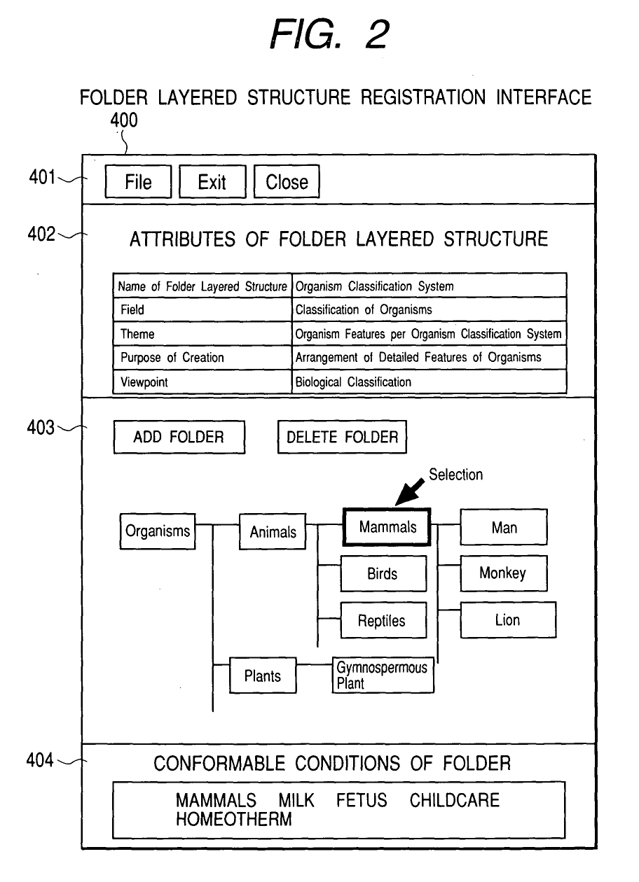

The details of the document management client program 130 are described with reference to FIGS. 2 to 4. The document management client program 130 includes a process (131) that allows an expert to create a folder layered structure in accordance with a field and a theme, a process (135) that selects a document to be classified automatically or a document to be discriminated automatically from the document file server 150, and a process (138) that displays an automatically classified or automatically discriminated result.

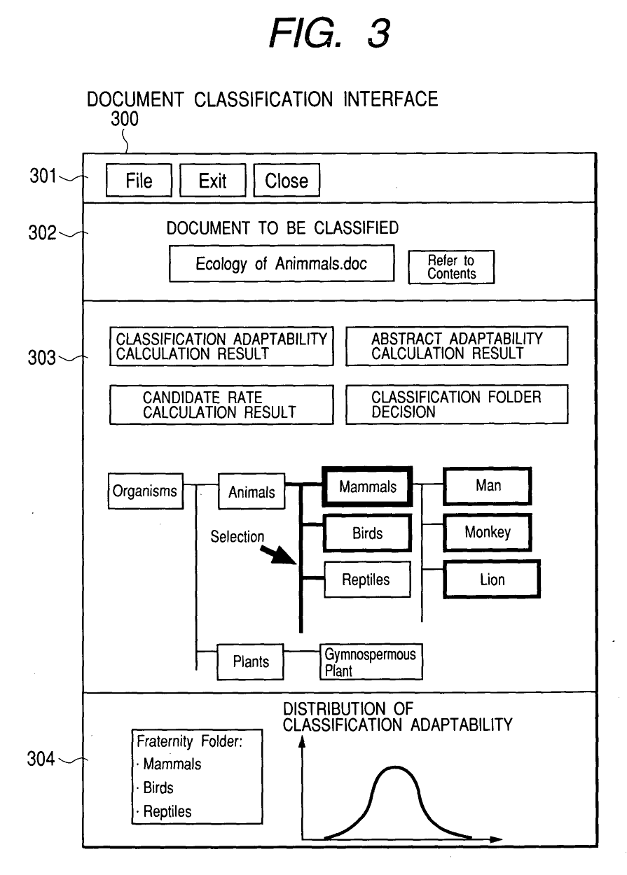

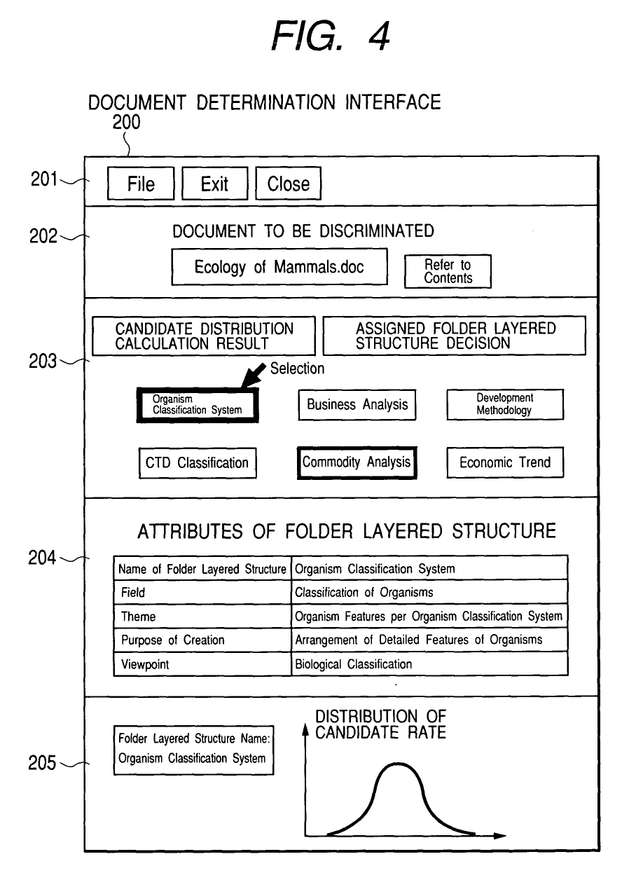

A user starts the document management client program 130. The document management client program 130 displays a folder layered structure registration interface 400 (refer to FIG. 2) that is a user interface used for allowing the user (expert or the like) to register a system as a folder layered structure based on a field and a theme, a document classification interface 300 (refer to FIG. 3) that is a user interface for classifying a document, and a document discrimination interface 200 (refer to FIG. 4) that is an interface that displays the field and theme of the document, and then performs necessary processing regarding each interface. Each interface is described.

FIG. 2 shows an example of the folder layered structure registration interface 400 that is a user interface for allowing the user (expert or the like) to register a folder layered structure. Each button of File, Exit, and Close is displayed in a display area 401. Illustration is omitted. When the user instructs the File button using a mouse pointer, a menu that selects save of input information or a program output result (for example, processing of giving a file name to the output result or input data and storing it in a storage device) is displayed. When the user instructs the Close button using the mouse pointer, program processing terminates. When the user instructs the Close button using the mouse pointer, a displayed window closes. Moreover, a similar case applies to a display area 301 of FIG. 3 and a display area 201 of FIG. 4. Further, these process show an example, and may also be provided with other functions.

In a display area 402, a user enters attribute values of the attributes (field, theme, purpose of creation, and viewpoint) of a folder layered structure an expert creates subsequently. In a display area 403, a user adds a folder and creates the folder layered structure. Further, in a display area 404, a user enters a document of the folder specified with a cursor and a folder conformable retrieval condition for the purpose of folder classification adaptability calculation. Moreover, these screen display and input aid screens are examples and a screen other than the illustrated screen may also be used.

The folder layered structure registration function 131 of the document management client program 130 accepts the input from these users. The attribute input function 132 accepts the information the user enters into the display area 402. The layer creation function 133 accepts the information the user enters into the display area 403. The condition input function 134 accepts the information the user enters into the display area 404.

Moreover, the folder layered structure registration function 131, the document classification display function 135, or the document discrimination display function 138 may even include a function that displays the screens of FIGS. 2 to 4 on a display device such as a display. The function may even include a processing unit that processes a user interface for the document classification display function 130 or may even use a browser or include another device.

FIG. 3 shows an example of the document classification interface 300 that is an interface for classifying a specific document. A user enters a file name (document name or the like) to be classified into a display area 302. The data of a file to be classified is displayed on another window by instructing the “Refer to Contents” button in the display area 302 by a screen pointer such as a mouse.

Calculation results of classification adaptability, abstract adaptability, and a candidate rate are displayed in a display area 303. Regarding a display method, the calculation results are displayed plainly for a user by changing display modes such as light and dark shading of color, a change in color, a change in size, or a change in a frame of each folder on a folder layered structure. For example, when the user presses the “Candidate Rate Calculation Result” button, the light and dark shading is displayed on the folder on the folder layered structure. This indicates that the candidate rate of a more densely colored folder is high and the candidate rate of a more thinly colored folder is low. Ease of use improves for the user by displaying the light and dark shading of the folder on a screen without displaying a numeric value result calculated in this manner using a numeric value as is.

Moreover, when a user (classifier or the like) moves a mouse cursor and selects a folder, then presses the “Classification Folder Decision” button in accordance with the automatic selection of the folder having the highest candidate rate or each calculation result, the folder that classifies an object document is decided. Further, when the processing of pressing the “Abstract adaptability calculation Result” is accepted from the user, a classification adaptability distribution graph for a sibling folder selected with the cursor is displayed in the display area 304. The user can visually check a condition of the distribution between the classification adaptability and classification adaptability for the sibling folder by seeing the graph displayed in the display area 304.

FIG. 4 shows an example of the document discrimination interface 200 that is an interface that discriminates a field and a theme of a document. The user interface 200 displays a document name to be discriminated in a display area 202. All names of the registered folder layered structure are displayed in a display area 203. When the “Candidate Distribution Calculation Result” button is pressed, size of candidate distribution is displayed in the name of each folder layered structure according to the light and dark shading of color, a change in color, a change in size, or a change in a frame.

For example, the folder layered structure of a dense color indicates that candidate distribution is high and the folder layered structure of a thin color indicates that the candidate distribution is low. At default, the attributes of the folder layered structure having the highest candidate rate are displayed in a display area 204 and the distribution state of the folder candidate rate for the folder layered structure having the highest candidate rate is displayed in a display area 205. A document discriminator can explicitly select a folder layered structure with the cursor and the attributes of the selected folder layered structure and the candidate rate distribution are displayed in the display areas 204 and 205 respectively.

When a user presses the “Assigned Folder Layered Structure Decision” button of the display area 203, it is decided that the attributes of the folder layered structure having the highest candidate rate or the folder layered structure the document discriminator selected explicitly are a field and a theme of a document.

An easy-to-use classification method for a user is provided by representing folder adaptability, classification adaptability, and a candidate rate for a document using the display of a graph or a folder tree structure instead of providing them as numeric data.

The details of the document management server program 100 are described below. The document management server program 100 receives data of a processing request from the document management client program 130 and automatically classifies or automatically discriminates a document in accordance with the received processing request, then sends a result to the document management client program 130.

The document management server program 100 calculates each numeric value in accordance with requests for processing the “Classification Adaptability Calculation”, “Abstract Adaptability Calculation”, “Candidate Rate Calculation”, and “Candidate Distribution Adaptability Calculation” from the document management client program 130 and received data. When the document management server program 100 receives the request for the “Classification Adaptability Calculation”, the processing of the classification adaptability calculation unit 111 is executed. When the document server program 100 receives the processing request for the “Abstract Adaptability Calculation”, the abstract adaptability calculation unit 112 is performed using the result of the classification adaptability calculation unit 111. When the document management server program 100 receives the request for the “Candidate Rate Calculation”, the candidate rate calculation unit 113 is performed based on the result of the abstract adaptability calculation unit 112.

Further, when the document management server program 100 receives the processing request of the “Candidate Distribution Calculation”, the candidate distribution calculation unit 121 performs the processing of the candidate distribution calculation based on the result of the candidate rate calculation unit 113. The result calculated and processed by the document management client program 130 based on the request received from the document management server program 100 is returned to the document management client program 130.

Further, the classification adaptability calculation unit 111 conforms to the adaptability calculation method of Japan Unexamined Patent Application Publication No. Hei 7-9075 and the abstract adaptability calculation unit 112 conforms to Procedure 1 described below. The candidate rate calculation unit 113 conforms to Procedure 2 described below, and the candidate distribution calculation unit 121 conforms to Procedure 3 described below.

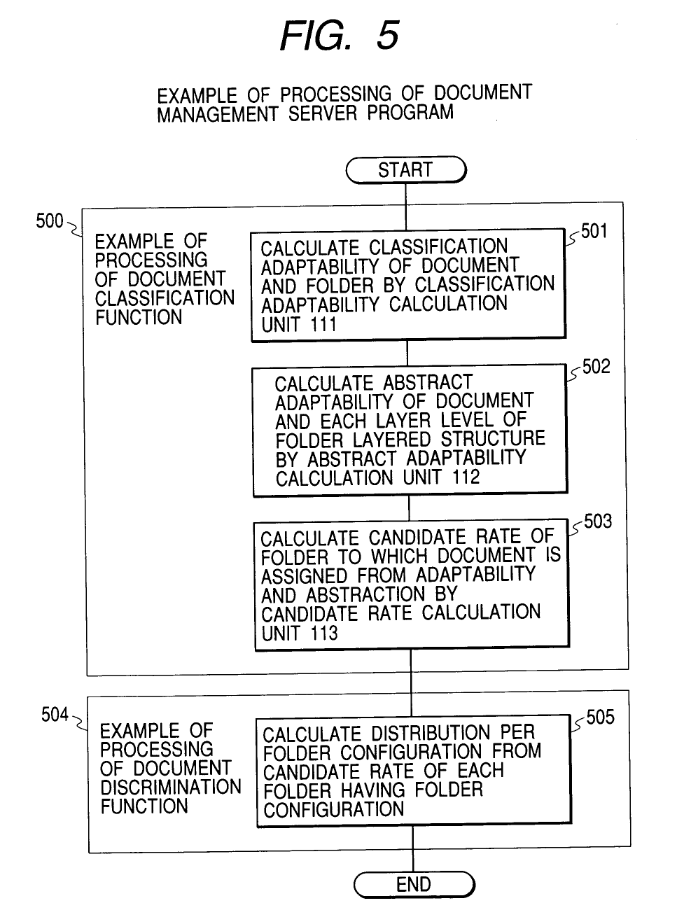

FIG. 5 shows an example of the processing of the document management server program 100. The processing of the document management server program 100 includes processing 500 of a document classification function and processing 504 of a document discrimination function. As shown in FIG. 5, after classification adaptability of a folder and a document are calculated in Step 501, abstract adaptability of each layer level of a folder layered structure and a document is calculated in Step 502 using the classification adaptability as the process of the document classification function 110. In Step 503, a folder candidate rate is calculated from the classification adaptability and the abstract candidate rate and a document is classified into the folder having the highest candidate rate. As the process of the document discrimination function 120, distribution every folder configuration is calculated in Step 505 from the obtained folder candidate rate.

The calculation of abstract adaptability and a candidate rate calculation is described below.

First, the abstract adaptability is described.

The abstract adaptability calculation unit 112 calculates the abstract adaptability of each layer level of a folder layered structure and a document. The abstract adaptability is a value indicating a possibility of the document being assigned to a specific sibling folder on the folder layered structure.

The basic concept of an abstract adaptability calculation method is based on the fact that when a layer level on a folder layered structure, that is, an abstract concept of a layer and abstraction of description contents of a document matches, the document can be classified clearly into the folder within the layer level. That is, the document having a big difference in the classification adaptability between the sibling folders is classified and stored.

For example, as shown in FIG. 7, there are “Mammals” as a upper folder and a “Man”, a “Monkey”, and a “Dog” are assumed as lower folders. The classification adaptability of a document that deals with the “Mammals” into each folder using the “Monkey” or “Dog” as examples is the upper numeric value of each folder of FIG. 7. The classification adaptability of the document into the lower folders “Man”, “Monkey”, and “Dog” is 0.33 to 0.42. If it becomes clear that the difference of this classification adaptability is big and the document is assigned to a specific folder, the possibility of the document being assigned to a layer level including the “Man”, “Monkey”, and “Dog”, that is, the abstract adaptability of a document and the folder layer level increases. On the other hand, if the difference of adaptability is small, that is, a folder to be classified cannot be made clear, the possibility of the document being assigned to the layer level of the “Man”, “Monkey”, and “Dog” is reduced and the abstract adaptability of a document and the folder level decreases.

For example, in the case of a document that deals with “Mammals” by use of the illustration of the “Man” and “Monkey” frequently, the classification adaptability of two folders of the “Man” and “Monkey” increases. Among three sibling folders of the “Man”, “Monkey”, and “Dog”, the meaning that the classification adaptability of the two folders increases indicates that the classification adaptability of a specific folder is not prominent and the specific folder cannot be classified clearly. That is, the abstract adaptability of a sibling layer level of the “Man”, “Monkey” and “Dog” indicates a low numeric value, and it is suggested that the abstraction of the sibling layer level of the “Man”, “Monkey”, and “Dog” on a folder layer and the abstraction of a document differ.

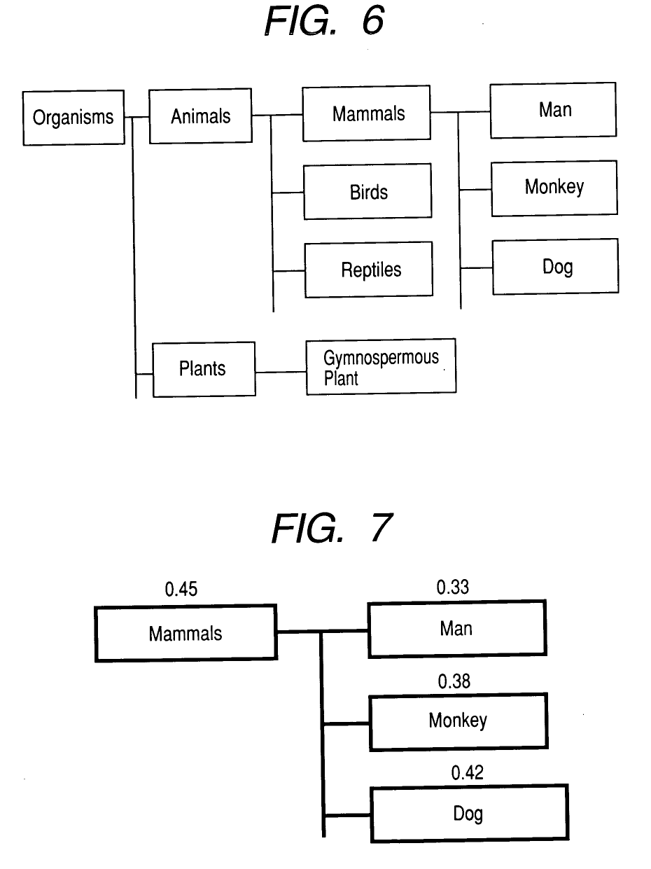

Similarly, in the “Mammals”, “Birds”, and “Reptiles” (refer to FIG. 6) of the sibling layer level to which the upper folder “Mammals” of the “Man”, “Monkey”, and “Dog” are assigned, the document that deals with the “Mammals” using the illustration of the “Man” and “Monkey” frequently shows that the classification adaptability of the “Mammals” folder increases and the classification adaptability of another folder is a low value. In this case, the classification adaptability of the specific folder “Mammals” is prominent, that is, this indicates that the abstract adaptability is high. It is suggested that the document is dealt with in an abstract level including the “Mammals”, “Birds”, and “Reptiles”.

Moreover, the drawing of FIG. 7 is an example for describing classification adaptability. The classification adaptability may be even managed using information with which folder information and adaptability are associated or using even another method.

A specific calculation method of abstract adaptability is shown. The abstract adaptability uses kurtosis that is a statistic of classification adaptability.

The kurtosis shows a shape of data distribution. If the kurtosis is 0, the shape shows the same distribution as normal distribution. If the kurtosis >0, the shape shows a shape of distribution whose center becomes sharp and whose skirt is drawn long. That is, it is indicated that a value of specific data is prominent. Further, if the kurtosis is lower than 0, the shape shows flat distribution and it is indicated that there is little difference between data items. A method for obtaining the kurtosis is represented in Expression (1).

$$Kurtosis = \frac{1}{n} {\sum }_{i = 1}^{n} {( \frac{{x}_{i} - \overline{x}}{s} )}^{4} - 3 \qquad ( 1 )$$

Where,

\overline{x}: Average of Data

s: Standard Deviation of Data

n: Number of Data Items

The kurtosis is an index that indicates a distribution state of data and determines that the data is biased to special data and there is little bias of the data. This index is used for abstract adaptability. That is, if there is the classification adaptability of the folder as shown in FIG. 7, the classification adaptability 0.42 of the “Dog” folder is higher than the classification adaptability of another folder. How much the classified adaptability of the “Dog” folder is a prominent value, however, can be suggested in comparison with the classification adaptability of the “Man” and “Monkey” folders using the kurtosis.

If the kurtosis value of the classification in the sibling folder including the “Man”, “Monkey”, and “Dog” of FIG. 7 is high, there is a high possibility of a document being classified into the “Dog” folder. At the same time, there is also a high possibility of the document dealt with in a layer level including the “Man”, “Monkey”, and “Dog”. This is because the meaning that a difference in classification adaptability is clear in the classification of the “Man”, “Monkey”, and “Dog” indicates that the document is dealt with in a standpoint that can be divided by the “Man”, “Monkey”, and “Dog” and indicates that the abstract level of the document is classified by the “Man”, “Monkey”, and “Dog”.

On the other hand, if the kurtosis value is low, it is indicated that a document cannot be classified clearly into the “Man”, “Monkey”, and “Dog” and the document is not dealt with from the standpoint of the “Man”, “Monkey”, and “Dog”. Otherwise, it means that the document is not treated in the abstract level of the “Man”, “Monkey”, and “Dog”.

Based on the aforementioned idea, abstract levels of description contents of a document and each folder layer can be obtained from the kurtosis of the classification adaptability of a sibling folder.

Procedure 1 for obtaining the kurtosis that is abstract adaptability is shown below.

Procedure 1

1. Calculate the classification adaptability of a document and all folders.

2. Rearrange the classification adaptability of multiple sibling folders in an ascending order.

3. Add classification adaptability behind rearranged data in a descending order of the data again so that the highest classification adaptability can be averaged.

4. Obtain the average of classification adaptability (this becomes the highest classification adaptability).

5. Obtain a standard deviation of classification adaptability.

6. Obtain kurtosis k of classification adaptability from Expression (1) and use it as the abstract adaptability of a sibling folder layer level.

In other words, that kurtosis is large indicates a great possibility that a sibling folder layer level whose abstract adaptability obtained from Procedure 1 is high and the abstraction of a document match.

Subsequently, a candidate rate calculation method is shown specifically. The candidate rate of a specific folder is obtained from Expression (2).

Candidate Rate=Classification Adaptability×Abstract Adaptability (2)

The procedure is listed below.

Procedure 2

1. Calculate the classification adaptability of a document and all folders.

2. Calculate the abstract classification of all sibling folders (conform to the aforementioned Procedure 1).

3. Calculate a candidate rate for each folder from Expression (2) using classification adaptability and abstract adaptability.

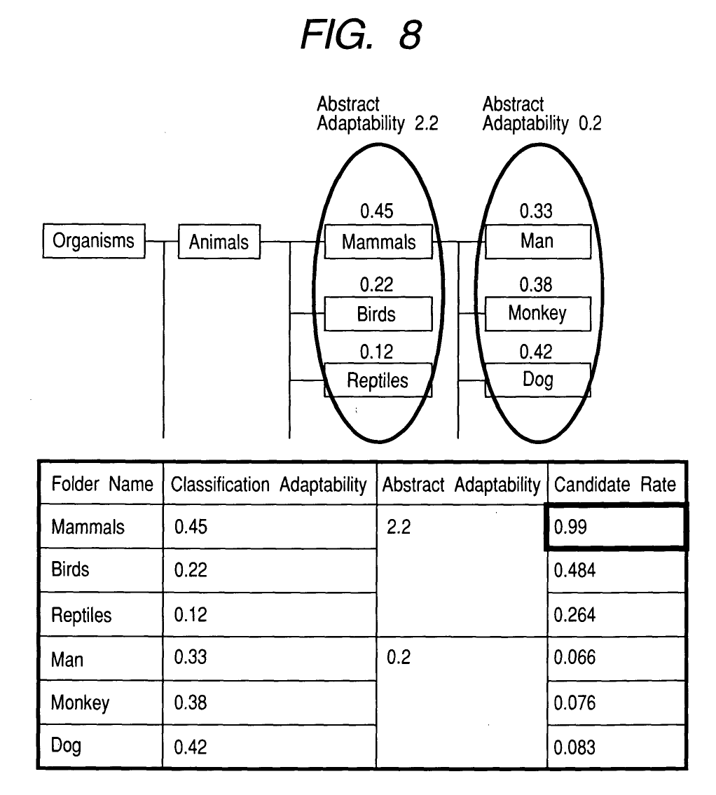

FIG. 8 shows an example of the classification adaptability every folder, the abstract adaptability of a sibling folder, and a candidate rate. The classification adaptability into each folder is displayed on top of the folder. The upper numeric value in which the sibling folder is enclosed by an ellipse is the abstract adaptability of the layer level of the sibling folder. Further, the table of FIG. 8 lists candidate rates at which the classification adaptability and abstract adaptability of each folder are multiplied. In the table, the candidate rate of the “Mammals” is highest. That is, there is the highest possibility of the object document being assigned to the “Mammals” folder. Thus, the candidate rate becomes a value in which the degree of matching between an abstract concept on a folder layered structure and an abstract concept of a document is considered as well as the adaptability of the document and each folder.

When a folder into which a document ought to be classified is decided in accordance with a candidate rate, the abstraction of each layer on a folder layered structure and the abstraction of description contents of the document can be matched.

Hereupon, as shown in the example 504 of the processing of the document discrimination function in FIG. 5, the candidate distribution calculation 121 that obtains the bias of a folder candidate rate in a folder layered structure is performed. Subsequently, the assignment of a document to the folder layered structure having the highest candidate distribution is decided and the field, theme, purpose of creation, and viewpoint of the document are automatically discriminated.

The basic idea of this processing determines that a folder layered structure in which a folder to which a document ought to be assigned is the folder layered structure to which the document ought to be assigned, and discriminates that a field, a theme, a purpose of creation, and a viewpoint set in the folder layered structure as attributes are the field, theme, purpose of creation, and viewpoint of the document.

That is, in a folder layered structure systemized from the standpoint that matches with the field, theme, purpose of creation, and viewpoint of a document, the document is classified clearly into a specific folder on the folder layered structure. On the other hand, in the folder layered structure systematized from the standpoint that differs in the field, theme, purpose of creation, and viewpoint, a folder to which a document is assigned cannot be specified clearly.

Specifically, if the candidate rate of a folder B of a document A is more prominent and higher than that of another folder in a folder layered structure C to which the folder B is assigned, there is a high possibility of the field and the theme of a document A matching with the field and theme set as the attributes of the folder layered structure C.

On the other hand, when there is little difference between the folder candidates of the folder layered structure C in the document A, there is a high possibility of the field and the theme of the document A not matching with the field and the theme set as the attributes of the folder layered structure C.

The setting of a folder layered structure is described.

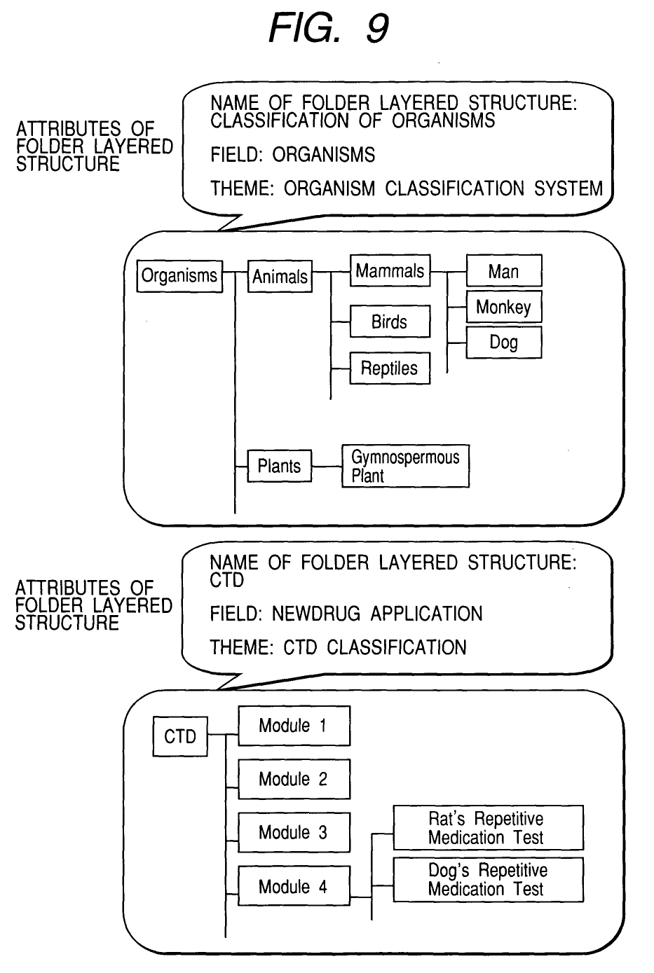

An expert prepares a classification system beforehand that complies with each field and theme. For example, a biologist prepares the folder layered structure (refer to FIG. 6) based on the classification system prepared in the theme of organism classification. Values in which it was made clear that in what field, theme, purpose of object, and viewpoint the expert systematized each folder layered structure are set as the attribute values of the folder layered structure (refer to FIG. 9). Further, the expert sets a conformable conditional expression (refer to Japan Unexamined Patent Application Publication No. Hei 7 (1995)-49875) for each folder and prepares a folder layered structure that covers the field and the theme a document that may possibly occur deals with.

The candidate distribution calculation 121 is described.

Candidate distribution is used as an index that indicates the matching between a document and a folder layered structure. A method for obtaining the candidate distribution is shown below. The candidate distribution uses a folder candidate rate. If the distribution of the folder candidate rate is obtained for every folder layered structure and the distribution of the candidate rate of a document is biased to a specific folder, there is a high possibility of the document being assigned to the folder layered structure.

The candidate distribution uses kurtosis that is a statistic of a candidate rate. This kurtosis is the same as the kurtosis of classification adaptability when abstract adaptability was obtained. In the abstract adaptability, the degree of the bias of the classification adaptability of a sibling folder was calculated. In candidate adaptability, however, the degree of the bias of a folder candidate rate in a folder layered structure is calculated. The kurtosis is obtained from Expression (1).

Subsequently, a kurtosis calculation method of the folder candidate rate that is the candidate distribution of a folder layered structure is shown. This calculation method is basically the same as a method that calculates abstract adaptability, but the difference is the presence of the layered structure. In the abstract applicability, a sibling folder was targeted, but in the kurtosis calculation, there is no relationship of the layered structure between the folders.

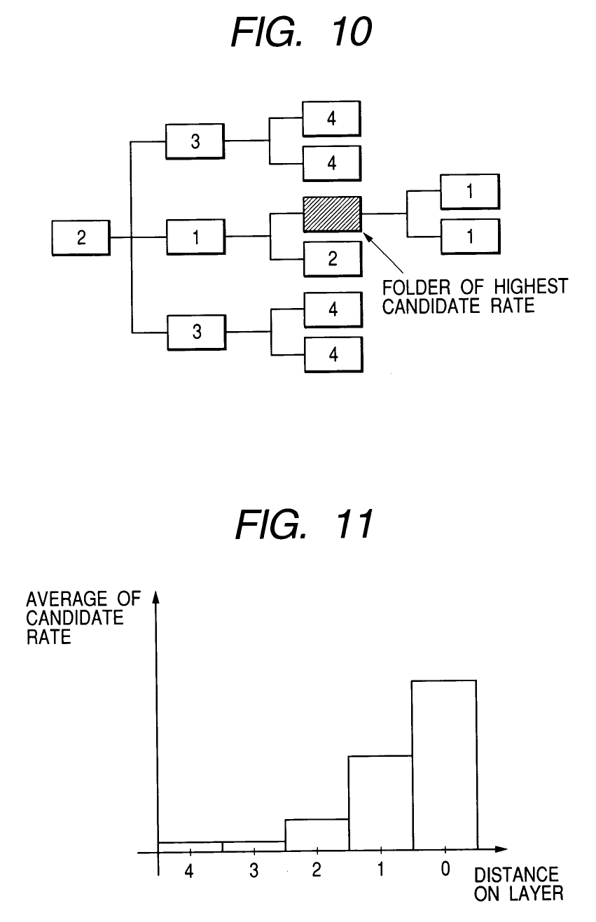

Nevertheless, because the distribution of the candidate rate between the folders of the entire folder layered structure is calculated in the candidate distribution, the distribution of the folder candidate rate is affected by the relationship of the folder layered structure. Accordingly, distance on a layer shown in FIG. 11 is used. The distance of an object folder from the folder (folder marked by oblique lines in FIG. 10) having the highest candidate rate of FIG. 10 is obtained respectively. The distance is the number of folders in which a descendant or an ancestor passes through from the folder having the highest candidate rate to the object folder.

For example, the distance of a parent folder of the folder having the highest candidate rate is set to 1 and the distance of a child folder is also set to 1. Because a sibling folder passes through the parent folder, the distance is set to 2.

As this distance is nearer on a folder layered structure, there is a great possibility of a folder candidate rate being high. Accordingly, as shown in FIG. 11, the average of the folder candidate rate is obtained every distance and the folder candidate rate is arranged in descending order of the distance. If the candidate rate of a specific folder is prominent and high, the kurtosis of the folder candidate rate rearranged as shown in FIG. 11 increases. On the contrary, when there is little difference in the folder candidate, the kurtosis of the folder candidate rate decreases.

Specifically, Procedure 3 for obtaining candidate distribution of a folder layered structure using the kurtosis of a folder candidate rate is shown below.

Procedure 3

1. Obtain the classification adaptability of a document and all folders.

2. Obtain abstract adaptability for each of all sibling folders.

3. Obtain the candidate rates of all folders using classification adaptability and abstract adaptability. (Same as Procedure 2 up to this step)

4. Obtain the candidate distribution of a folder layered structure for all folder layered structures in the following procedure.

i) Decide a folder having the highest candidate rate in a folder layered structure.

ii) Obtain distance from a folder having the highest candidate rate for all folders.

iii) Obtain the average of a folder candidate rate for every distance.

iv) Rearrange the average of a folder candidate rate in a descending order of distance.

v) Add the average of a folder candidate rate again behind the average of the rearranged folder candidate rate in an ascending order of distance so that the highest folder candidate rate can be averaged.

vi) Obtain the average of a folder candidate rate (this become the highest folder candidate rate).

vii) Obtain a standard deviation of a folder candidate rate.

viii) Obtain kurtosis k from Expression (1) and use it as the candidate distribution of a folder layered structure.

The decision of document attributes is described.

Subsequently, an automatic discrimination method of a field and a theme of a document is described. Candidate rate distribution is obtained from Procedure 3 regarding all the folder layered structures. A folder layered structure having the highest candidate rate distribution is selected. That the candidate rate distribution is maximum means that a document can be clearly classified into a specific folder having a specific folder layered structure. That is, this means that the standpoint described in a document and the standpoint from which a folder layered structure is systematized are similar to each other.

Accordingly, an object document is assigned to a system based on a folder layered structure setting in which the candidate rate distribution is maximum. When the folder layered structure is systematized, standpoints such as a field, a theme, and a purpose of creation match with the field, theme, and purpose of creation of the contents described in a document.

As a result, it can be estimated that values (field, theme, purpose of creation, and viewpoint of a folder layered structure whose candidate distribution is maximum are the field, theme, purpose of creation, and viewpoint of a document whose contents are unknown.

The suggestion of the correction of a folder layered structure is described.

When the maximum candidate distribution is lower than the set threshold, that is, in some cases, it cannot be made clear that which folder layered structure a document is assigned to. When the folder layered structure to the document ought to be assigned cannot be made clear in this manner, the following problems will be caused.

1. A prepared folder layered structure is insufficient. That is, there is no folder layered structure systematized according to the field and the theme described in the contents of a document.

2. A prepared folder layered structure does not match with actual conditions. That is, although a new classification item was added academically and substantially, the new classification item is not added to a folder system having a folder layered structure.

When a document occurs frequently in which the candidate distribution of the folder layered structure does not exceed a threshold, it can be suggested that it is a time to review and change the prepared folder layered structure.

For example, a message indicating “The candidate distribution of the folder layered structure goes below threshold A. The present folder layered structure must be reviewed.” may also be displayed for a user or a mail address of a user (file administrator or classifier) is registered beforehand and the message may be also reported to the administrator by mail. Further, the contents of this notification may also include a file name of a file that strays off from candidate distribution and a folder name of a file-related folder.

As described above, the following effects are obtained by the document classification function of the present invention.

(1) A document can be classified accurately with less labor.

(2) Abstraction of description contents of a document and the abstraction of a folder on a folder layered structure to be classified can match.

(3) The setting of a folder conformable condition is facilitated. That is, a folder conformable conditional expression in which the level abstract concept of a folder layer on a folder layered structure is taken into consideration need not be set.

Further, the following effects are obtained by the document decision function.

(1) When the field or theme of the contents described in a document is discriminated, an expert need not read the document carefully.

(2) A discrimination error or bias caused by habits or characters of a discriminator of a field and a theme can be eliminated.

(3) A field and a theme expressed by a word that does not occur in a document can be discriminated.

Further, the present invention can provide a program that allows a user to understand an index easily in the course of classifying a document in order to graphically represent conformable conditions of a folder and a file stored in the folder and classification applicability in the course of classifying the document.

The present invention allows the user to classify a document with lesser labor and facilitate the setting of a folder conformable condition.

What is claimed is:

1. A document management method using a computer, comprising the steps of:
accepting input of a file name from a user;
reading information about a previously stored folder;
calculating classification adaptability based on said accepted file name and said read information about said folder; and
displaying said calculated classification adaptability and said read information about said folder on a screen.

2. The document management method according to claim 1, wherein distribution of the classification adaptability is displayed graphically on said screen.

3. A document management program for executing a document management method using a computer, including:
said method, comprising the steps of:
accepting input of a file name from a user;
reading information about a previously stored folder;
calculating abstract adaptability based on said accepted file name and said read information about said folder; and
displaying said calculated abstract adaptability and said read information about said folder on a screen.

4. The document management program according to claim 3, wherein a structure of a folder is displayed on said screen using a drawing and said displayed folder is highlighted based on abstract adaptability.

5. A document management system, including:
means for accepting input of a file name from a user;
means for reading information about a previously stored folder;
means for calculating classification adaptability based on said accepted file name and said read information about said folder; and
means for displaying said calculated classification adaptability and said read information about said folder on a screen.

6. A document management method using a computer, comprising the steps of:
accepting input of a document name from a user;
calculating abstract adaptability of a document for every layer of a folder based on information about the folder stored in a storage device previously and classification adaptability;
calculating a candidate rate of the folder based on said abstract adaptability and said classification adaptability; and
storing a document associated with said document name in a folder in which a value of the candidate rate of said folder is high.

7. The document management method according to claim 6, wherein candidate distribution of a layered structure of a folder is calculated using the candidate rate of said folder and the layered structure of the folder in which to store a document is discriminated based on the candidate distribution of said calculated folder.

8. The document management method according to claim 6, wherein abstract adaptability of a folder is calculated as kurtosis of classification adaptability in said abstract adaptability calculation.

9. The document management method according to claim 6, wherein a candidate rate of a folder is calculated based on classification adaptability and abstract adaptability to calculate the candidate rate of said folder, and
a result of said calculation is displayed by changing a display mode of the folder in a folder layered structure.

10. The document management method according to claim 6, wherein candidate distribution of a folder layered structure is calculated as kurtosis of a candidate rate of the folder assigned to the folder layered structure to calculate the candidate distribution of said folder, and
said calculated candidate rate is displayed as a distribution graph.

11. The document management method according to claim 10, wherein a display mode of a folder is changed to display said candidate distribution as the distribution graph based on information about said candidate distribution and said folder.

12. A document management method using a computer, comprising the steps of:
allowing said computer to calculate candidate distribution based on information about a previously stored folder and information about a file;
deciding a folder to which a file ought to be assigned based on said calculated candidate distribution; and
displaying a message that prompts correction of a structure of a folder when said candidate distribution is lower than a previously stored threshold as a result of said decision.
